(19) United States
(12) Patent Application Publication
(10) Pub. No.: US 2007/0241074 A9
(43) Pub. Date: Oct. 18, 2007

(54) Pipelayer crane excavator apparatus and methods

(76) Inventor: Daniel Edward Davis, Harlingen, TX (US)

Correspondence Address: PATTERSON & SHERIDAN, L.L.P., 3040 POST OAK BOULEVARD, SUITE 1500, HOUSTON, TX, 77056, US

(21) Appl. No.: 11/125,691

(22) Filed: May 10, 2005

Related U.S. Application Data
(63) Continuation-in-part of application No. PCT/US03/07613, filed on Mar. 11, 2003.

(51) Int. Cl. B66C 23/00

(52) U.S. Cl. 212/238

(57) ABSTRACT

The pipelayer crane apparatus comprises a lower, the lower comprising a lower frame, a pedestal, a lower bearing portion, a telescoping axle, a track roller, and a track shoe, an upper, the upper comprising a frame, a body, a cab, a pedestal, a upper bearing portion, and a counterweight, a lifting assembly, the lifting assembly comprising an adjacent portion, a remote portion, a joint, and a cylinder and a weldment, the weldment comprising a body, an extension, a winch, and securing members. A method for a pipelayer crane apparatus to rotate about the track shoes comprising a lower, the lower having a pedestal attached to a lower bearing surface; an upper, the upper having a pedestal attached to a upper bearing portion; bearing formed by the interaction of the upper bearing surface and the lower bearing surface; a pipe lifting assembly, the pipe lifting assembly attached to a weldment, the weldment attached to the upper; and the upper rotating about the bearing formed by the upper bearing surface and the lower bearing surface.

### FIELD OF THE INVENTION

The present invention relates generally to a pipelayer crane excavator apparatus and associated methods. More particularly, the present invention relates to a pipelayer, crane and excavator apparatus having excavator-like, fundamental components, and attachments and methods for converting the apparatus from or to an excavator, a pipelayer or a crane as well as methods of preparing and transporting the apparatus.

### BACKGROUND OF THE INVENTION

Material handling equipment is very expensive. Each piece of equipment can represent a significant investment to accomplish a very specific or limited utility with respect to the piece of equipment. It can be appreciated that any time saved in the movement of materials equates to greater profits from the saved time. Also, the need exists to have equipment that can be easily transported on public roads. Traditional construction vehicles and equipment are very large and must be partially disassembled to be transported from one location to another.

It is well known in the art that crawler or tractor-type vehicles having an integrated, rigid maneuverable boom disposed on a side of the tractor are for pipelaying operations, such as for example, raising, carrying, and lowering heavy pipe. Pipelayers are sometimes referred to in the art as “sidebooms.” Pipelayers or sidebooms must be capable of safely handling heavy pipe.

Pipelayers or sidebooms which manipulate large diameter pipe for the construction of pipelines are a specialized type of equipment. For over 70 years, pipelayers have been equipped with specialized tools and frames for supporting and manipulating the large heavy pipe sections. Such tools and frames generally include a pipe supporting boom arm, a counterweight assembly, a draw works or winch assembly, and a pipelayer frame assembly for supporting the boom arm, the counterweight assembly, and the drawworks. Most prior art pipelayers utilize a cable connected between the drawworks and the boom arm, and by running the cable in or out, the boom arm and the pipe are raised and lowered.

More recently, fluid powered linear motors or cylinders have been used to replace the drawworks and cable for raising and lowering the boom arm and pipe. One such prior device is shown in U.S. Pat. No. 4,966,290, issued to H. Ejchler, et al. on Oct. 30, 1990. The Ejchler patent provides for storage of a fluid cylinder on the pipelayer during transportation, without the necessity to disconnect fluid lines. Another such device is shown in U.S. Pat. No. 4,042,116, issued to G. M. Bertolino on Aug. 16, 1977. In the Bertolino patent, maneuvering of the movable boom is controlled by a large hydraulic jack. The jack is connected between one end of the boom and a supplemental support or framework. Another type of structure for maneuvering a boom or jib is shown in U.S. Pat. No. 3,842,983, issued to C. Dolza on Oct. 22, 1974. In the Dolza patent, the jib is raised and lowered, and pivoted laterally, by a plurality of hydraulic jacks. In each of the cylinder-driven, boom manipulating devices, removal of the boom would normally be necessary to transport the vehicle. With the boom removed, one end of the cylinder, or cylinders, becomes unsupported, which requires the cylinders to be removed or stored on the machine in some manner. Removal of the fluid cylinders necessitates disconnecting and plugging of several fluid lines. The possibility of fluid loss and contamination of the fluid system is always a concern when fluid lines are disconnected. When the fluid cylinders are removed, they must be stored and shipped separately, thereby requiring additional space and effort. Also, considerable time and effort are required to re-assemble the fluid cylinders to the pipelayer.

In addition, hydraulically-operated high-drive sidebooms are very expensive, and some models have counterweight obstruction problems, and are difficult to move from job-site to job-site. While it is known that a hydraulic pipelayer may be adapted for mounting upon a conventional track-laying tractor, i.e., a bulldozer, it is also well known in the art that the main frame of a sideboom is constructed differently from that of a conventional tractor. In particular, unlike a conventional tractor which is constructed with an oscillating frame, a sideboom is constructed with a rigid frame of wider track gauge than a conventional tractor. Indeed, manufacturers of pipelayers identify such tractor and sideboom frames with different serial numbers series. Thus, to obtain the prerequisite performance demanded in the pipelaying art, typically a drawworks assembly must be mounted upon a frame capable of rigidity to accommodate the pivoting action of a sideboom which is typically positioned upon rough terrain, with the frame having a sufficiently wide track gauge for stability purposes.

Traditional pipelayer apparatuses do not rotate on their track shoes. The operator must pick up a piece of pipe and walk straight to the job location. Also, traditional pipelayer apparatuses must work in pairs to accomplish a job.

Also, traditional pipelayer apparatuses only allow the operator to look in front of the apparatus and to the operator's left when in a seated position.

It is, therefore, a feature of the present invention to provide a pipelayer apparatus that easily transported.

A feature of the present invention is to provide a pipelayer apparatus that can operate as a single pipelayer to accomplish the laying of pipe.

Another feature of the present invention is to provide a pipelayer apparatus with the ability to allow the operator to see the pipe being lifted at all times and in all directions such that the pipe can be rotated and yet remains in clear view of the operator.

Yet another feature of the invention is to provide a pipelayer apparatus that rotates on a bearing associated with a crawler drive system.

Still another feature of the present invention is providing a pipelayer apparatus that can be transported on public roads with the boom attached.

Yet still another feature of the present invention is to provide a pipelayer apparatus with a boom that articulates into a resting position for easy transport.

Yet further, an additional feature of the present invention is to provide a pipelayer crane apparatus that lifts a large capacity about a radius of 360 degrees, which radius can be many feet.

Still further, an additional feature of the present invention is to provide a method for lifting pipe, rotating the pipe about a radius and safely placing the pipe in a trench.

Still further, an additional feature of the present invention is to provide an apparatus and method for a pipelayer to lay pipe on either side of the pipelayer and in either direction along a trench.

Still further, an additional feature of the present invention is to provide a method for preparing a pipelayer for transport and for transporting the pipelayer on public roads.

Still further, an additional feature of the present invention is to provide a method for a single pipelayer apparatus to lay pipe without assistance from other pipelayers.

Still further, an additional feature of the present invention is to provide a method for quickly converting a pipelayer to an excavator, or alternately, converting an excavator to a piplayer.

Another feature of the present invention is to provide a method for quickly converting a pipelayer to a crane, or alternately, converting a crane to a piplayer.

Yet another feature of the present invention is to provide a pipelayer for heavy-duty, off-road applications having maximum maneuverability.

Another feature of the present invention is to provide an apparatus and method for using larger track pads on the pipelayer to lower the ground pressure created enabling the apparatus to work in environmentally critical areas and to provide floatation when working on soggy ground.

Another feature of the present invention is to provide an apparatus that can extend one track and keep retracted the other track for operating in restricted areas and changing the center of gravity.

### SUMMARY OF THE INVENTION

To achieve the foregoing objects, features, and advantages and in accordance with the purpose of the invention as embodied and broadly described herein, a pipelayer crane apparatus is provided.

The pipelayer crane apparatus comprises a lower, the lower comprising a lower frame, a pedestal, a lower bearing portion, a telescoping axle, a track roller, and a track shoe, an upper, the upper comprising a frame, a body, a cab, a pedestal, a upper bearing portion, and a counterweight, a lifting assembly, the lifting assembly comprising an adjacent portion, a remote portion, a joint, and a cylinder and a weldment, the weldment comprising a body, an extension, a winch, and securing members.

A method for a pipelayer crane apparatus to rotate about the track shoes comprising a lower, the lower having a pedestal attached to a lower bearing surface; an upper, the upper having a pedestal attached to a upper bearing portion; bearing formed by the interaction of the upper bearing surface and the lower bearing surface; a pipe lifting assembly, the pipe lifting assembly attached to a weldment, the weldment attached to the upper; and the upper rotating about the bearing formed by the upper bearing surface and the lower bearing surface.

### BRIEF DESCRIPTION OF THE DRAWINGS

The accompanying drawings which are incorporated in and constitute a part of the specification, illustrate a preferred embodiment of the invention and together with the general description of the invention given above and the detailed description of the preferred embodiment given below, serve to explain the principles of the invention.

FIG. 1 is a perspective view of the pipelayer apparatus of the present invention with the main frame rotated 90 degrees from the undercarrage.

FIG. 2 is a side view of the preferred embodiment of the pipelayer apparatus of the present invention as illustrated in FIG. 1 illustrating the boom at varying heights.

FIG. 3 is a front view of the preferred embodiment of the pipelayer apparatus of the present invention as illustrated in FIGS. 1 and 2.

FIG. 4 is a perspective view of the pipelayer apparatus of the present invention with the main frame rotated 90 degrees from the undercarrage as illustrated in FIG. 1.

FIG. 5 is a side view of the preferred embodiment of the pipelayer apparatus of the present invention as illustrated in FIG. 1 illustrating the weldment or adapter for connecting the boom to the main frame.

FIG. 6 is a side view of the weldment or adapter, the boom and the cylinder associated with the preferred embodiment of the pipelayer apparatus of the present invention as illustrated in FIG. 1.

FIG. 6A is a perspective view of the weldment or adapter of the preferred embodiment of the pipelayer apparatus of the present invention illustrated in FIG. 1.

FIG. 6B is a side view of the weldment or adapter of the preferred embodiment of the pipelayer apparatus of the present invention illustrated in FIG. 1.

FIG. 7 is a side view of the preferred embodiment of the pipelayer crane apparatus of the present invention illustrating the displacement of the boom in a counterclockwise direction.

FIG. 8 is a side view of another preferred embodiment of the pipelayer apparatus of the present invention illustrating another boom, two winch and weldment configuration.

FIG. 9 is a perspective view of another preferred embodiment of the pipelayer apparatus of the present invention illustrating different boom, cylinder, winch and weldment configuration.

FIG. 10 is a perspective view of the preferred embodiment of the pipelayer apparatus of the present invention illustrated in FIG. 9 with the main frame positioned 90 degrees from the undercarrage.

FIG. 11 is a perspective view of the preferred embodiment of the pipelayer apparatus of the present invention illustrated in FIG. 9 with the main frame positioned 45 degrees from the undercarrage.

FIG. 12 is a perspective view of the preferred embodiment of the pipelayer apparatus of the present invention similar to the embodiment illustrated in FIG. 9 with the main frame positioned 45 degrees from the undercarrage and having duel tracks.

FIG. 13 is a side view of another preferred embodiment of the pipelayer apparatus of the present invention illustrating a different boom, winch and weldment configuration.

FIG. 13A is a side view of yet another preferred embodiment of the pipelayer apparatus of the present invention illustrating a different boom, winch and weldment configuration.

FIG. 14 is a side view of another preferred embodiment of the pipelayer apparatus of the present invention illustrating a different boom, winch and weldment configuration.

FIG. 14A is a side view of the weldment used in the preferred embodiment of the pipelayer apparatus of the present invention illustrated in FIG. 14.

FIG. 15 is a side view of still another preferred embodiment of the pipelayer apparatus of the present invention illustrating a boom, winch and weldment configuration.

FIG. 16 is a side view of still another preferred embodiment of the pipelayer apparatus of the present invention illustrating a different boom, cylinder, winch and weldment configuration.

FIG. 17 is a side view of another preferred embodiment of the pipelayer apparatus of the present invention illustrating a different boom, cylinder, winch and weldment configuration.

FIG. 18 is a side view of still another preferred embodiment of the pipelayer apparatus of the present invention illustrating a boom, winch and weldment configuration.

FIG. 19 is a side view of still another preferred embodiment of the pipelayer apparatus of the present invention illustrating a boom attached with or without a weldment.

FIG. 20 is a side view of still another preferred embodiment of a modified pipelayer apparatus of the present invention having the boom attached to the main frame and a jib boom attached to the boom and a tool attached to the jib boom.

FIG. 21 is a plan view illustrating a preferred method of self-loading for the pipelayer apparatus of the present invention showing the pipelayer apparatus straddling a trailer, and an associated truck.

FIG. 22 is a plan view illustrating the preferred method of self-loading for the pipelayer apparatus of the present invention illustrated in FIG. 21 showing the pipelayer apparatus self-loaded on the trailer.

The above general description and the following detailed description are merely illustrative of the generic invention, and additional modes, advantages, and particulars of this invention will be readily suggested to those skilled in the art without departing from the spirit and scope of the invention.

### DETAILED DESCRIPTION OF THE PREFERRED EMBODIMENTS

Reference will now be made in detail to the present preferred embodiments of the invention as described in the accompanying drawings.

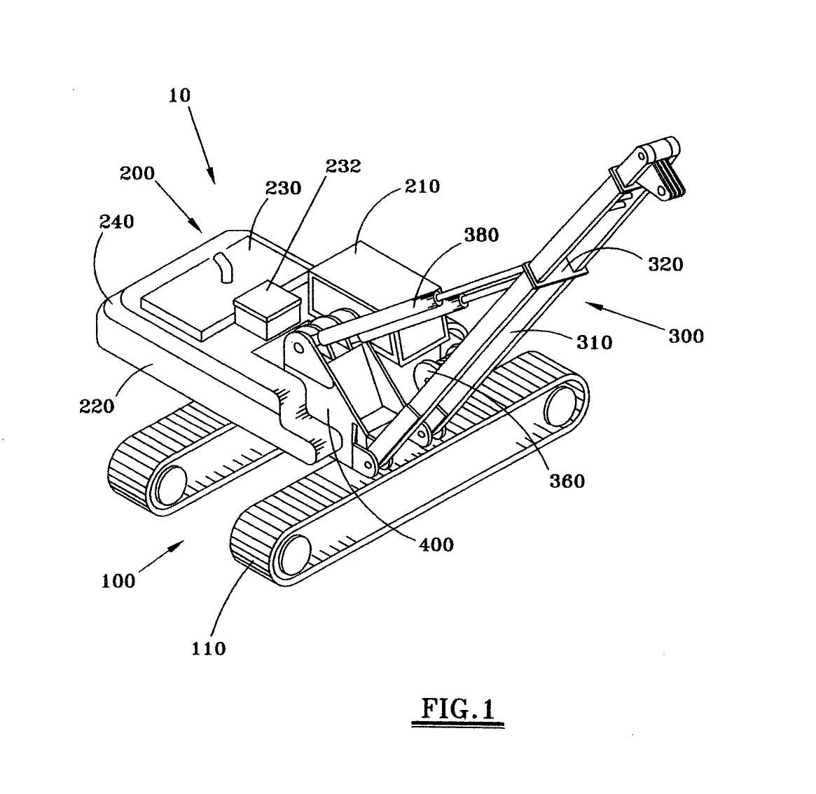

FIG. 1 is a perspective view of the pipelayer apparatus 10 of the present invention with the upper or main frame 200 rotated 90 degrees from the lower or undercarrage 100. This preferred embodiment illustrates a pipelayer crane apparatus 10 comprised of a lower or undercarrage 100, an upper or main frame 200, a lifting assembly 300, and an adapter or weldment 400. It is appreciated by those skilled in the art that the lower or undercarrage 100 and the upper or main frame 200 are of the type used in excavators, and not cranes. The upper or main frame 200 is illustrated with a counterweight 240 at one end and the lifting assemble 300 at the other end. Further, the upper or main frame 200 has an engine compartment 230 and an enclosed cab 210. The upper or main frame 200 removeably accepts the adaptor or weldment 400. The adaptor 400 is configured so as to be removeably joined with the upper 200 at the same locations that would be used if the upper 200 was used as an excavator and an excavator boom was attached. The lifting assembly 300 comprises the boom 310, a winch 360 and the cylinders 380. The lifting assembly 300 has a boom or A-frame 310 engaged with the adaptor 400 for removeably securing the boom 310 to rotate about a pivot point on the lower extremity of the adaptor 400. Also attached to the adaptor 400 in a rotating relationship is one end of the cylinder 380. In the present illustrated embodiment, two cylinders 380 are used, but it is appreciated by those skilled in the art that one or more cylinders may be adapted for use with the present invention. The other end of the cylinders 380 are rotatingly affixed to the boom 310. As the cylinders 380 are extended, the boom 310 is rotated about the pivot in the adaptor 400 and lowered. As the cylinders 380 are retracted, the boom 310 is rotated about the pivot in the adaptor 400 and raised.

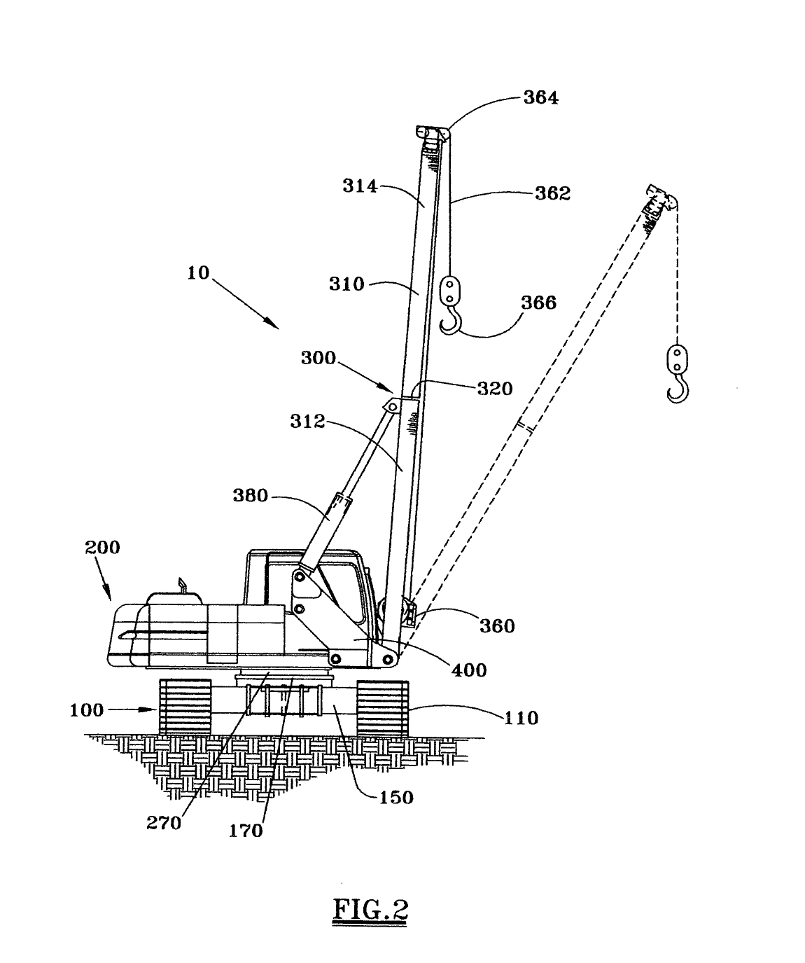

FIG. 2 is a side view of the preferred embodiment of the pipelayer apparatus 10 of the present invention as illustrated in FIG. 1 illustrating the boom 310 at varying heights. Generally, as illustrated in FIGS. 1 and 2, the lower or undercarrage 100 is comprised of a lower frame, a telescoping axle 150, a track roller, a track shoe 110, a pedestal, and a lower bearing 170. The lower frame is attached on its top side to the pedestal which is engaged with the lower bearing 170 and on each side to the telescoping axle 150. The telescoping axle 150 shortens to allow loading of the pipelayer crane apparatus 10 when a small footprint is needed. The telescoping axle 150 widens to give the pipelayer crane apparatus a wider footprint and lower ground pressure to allow for greater lifting capacities. The telescoping axle 150 is attached to a track roller. The track roller is then in communication with the track shoe 110. The track roller provides force from the power train to turn the track shoe 110 on each side to move the pipelayer crane apparatus 10. The lower frame is attached on its top side to the pedestal. The pedestal is attached to the lower bearing 170. The boom 310 has a lower boom section 312, an upper boom section 314 and a boom point remote from the end of the boom 310 attached to the adaptor 400. The lower boom section 312 and the upper boom section 314 are joined by a boom pivot 320. The boom pivot 320 provides for the upper boom section 314 to be rotated about the boom pivot 320 so as to fold the boom 310.

The lower 100 has the pedestal attached to the upper bearing portion 270. The lower bearing portion 170 of the lower 100 and the upper bearing portion 270 of the upper 200 comprise the bearing 112/212. The frame on the upper side is attached to the body and the cab 210. The counter weight 240 is attached on the rear portion of the frame to the rear of the cab 210. The frame may have a securing member. The securing member is attached to the front portion of the frame. The securing member is comprised of a first securing member and a second securing member. The securing member is attached the weldment 400.

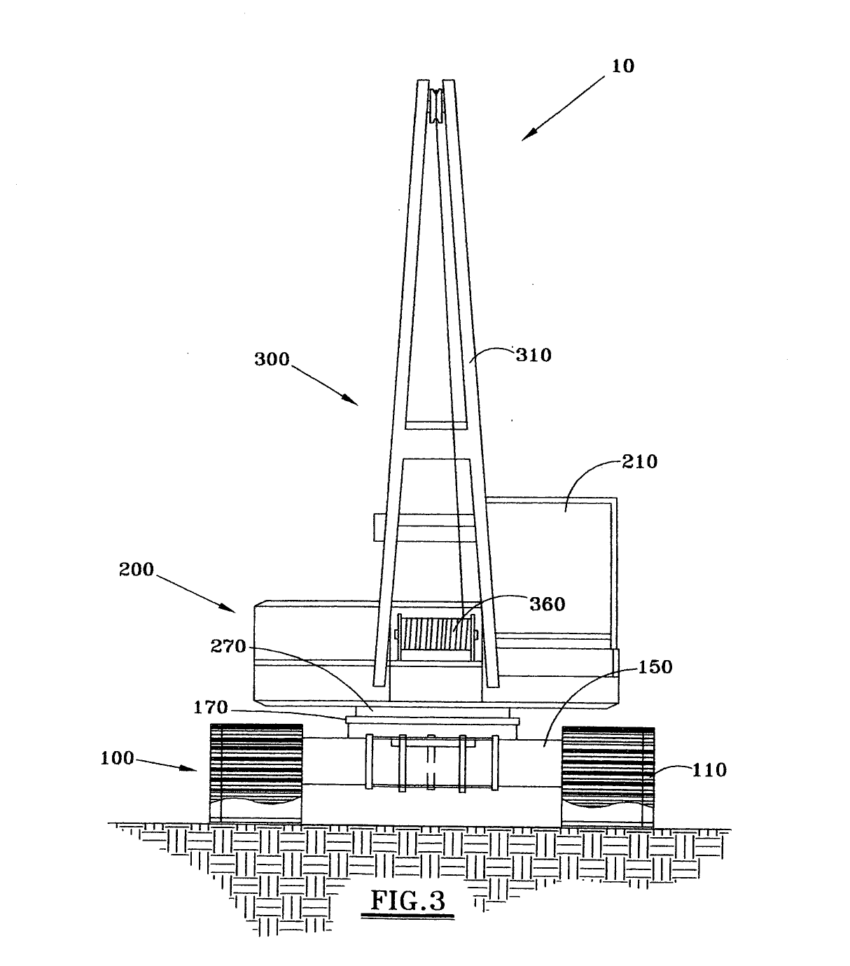

FIG. 3 is a front view of the preferred embodiment of the pipelayer apparatus of the present invention as illustrated in FIGS. 1 and 2. FIG. 3 illustrates the pipelayer apparatus 10 of the present invention with the relationship of the boom 310 and the winch 360. The lower 100 is shown with the track 110, the telescoping axle 150 and the lower bearing 170. The lifting assembly 300 is illustrated with the boom 310 and the winch 360.

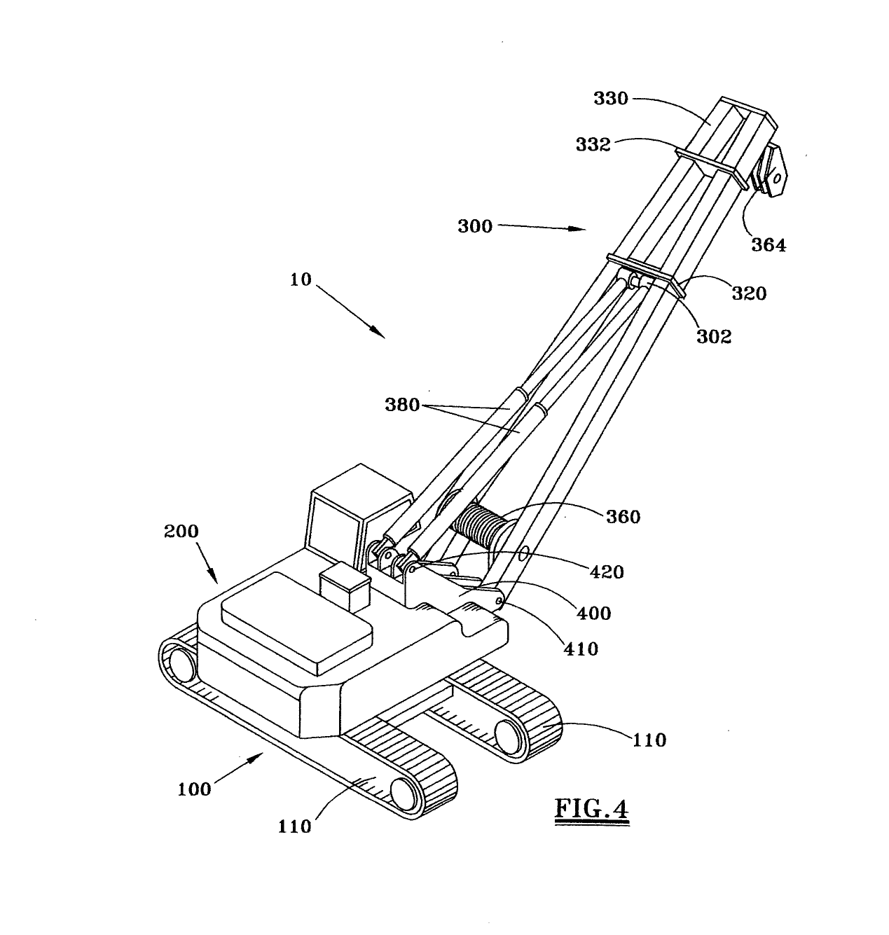

FIG. 4 is a perspective view of the pipelayer apparatus of the present invention with the main frame or upper 200 rotated 90 degrees from the undercarrage or lower 100 as illustrated in FIG. 1. The lower 100 has the tracks 110. The adaptor 400 is illustrated with a boom pivot 410 and a cylinder pivot 420. The lifting assembly 300 has the boom 310, the winch 360 and the cylinders 380. The boom 310 comprises the lower boom section 312, the upper boom section 314, the boom pivot 320, the boom point flange 332, the boom point 330 and the block 364.

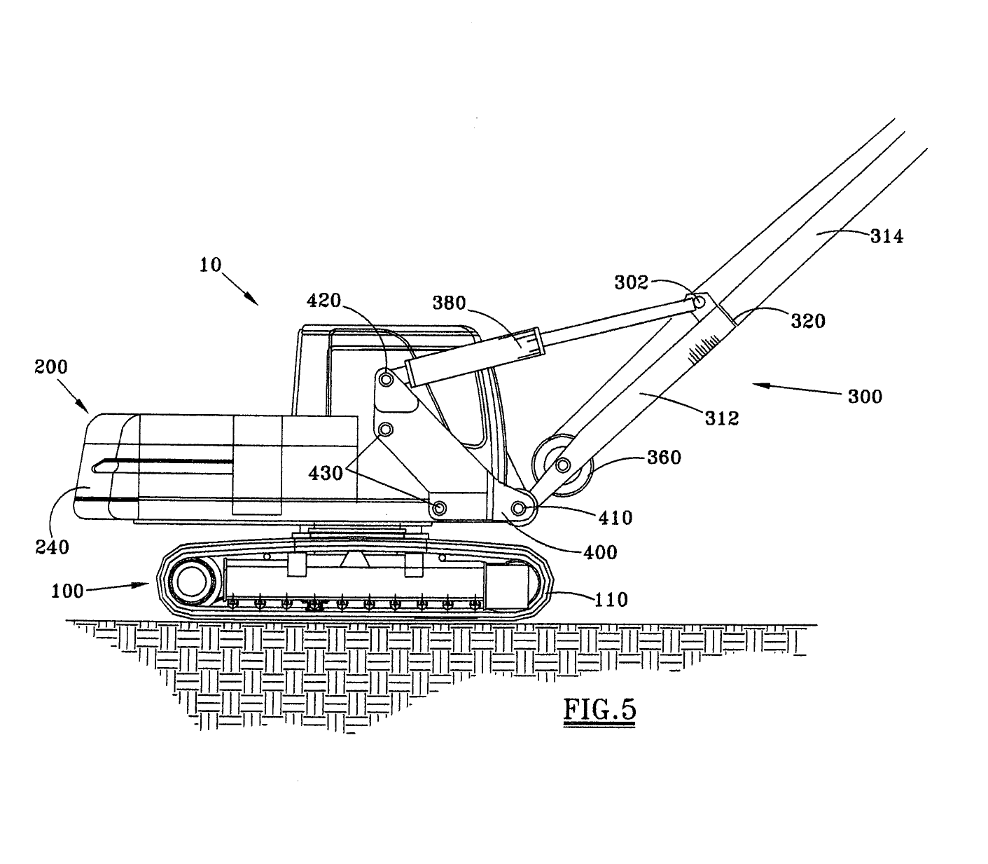

FIG. 5 is a side view of the preferred embodiment of the pipelayer apparatus 10 of the present invention as illustrated in FIG. 1 illustrating the weldment or adapter 400 for connecting the boom 310 to the main frame or upper 200. The adaptor 400 is illustrated with a boom pivot 410, a cylinder pivot 420 and the connections 430 to the upper 200. The lifting assembly 300 has the boom 310, the winch 360 and the cylinders 380. The boom 310 has the lower boom section 312, the upper boom section 314 and the boom pivot 320.

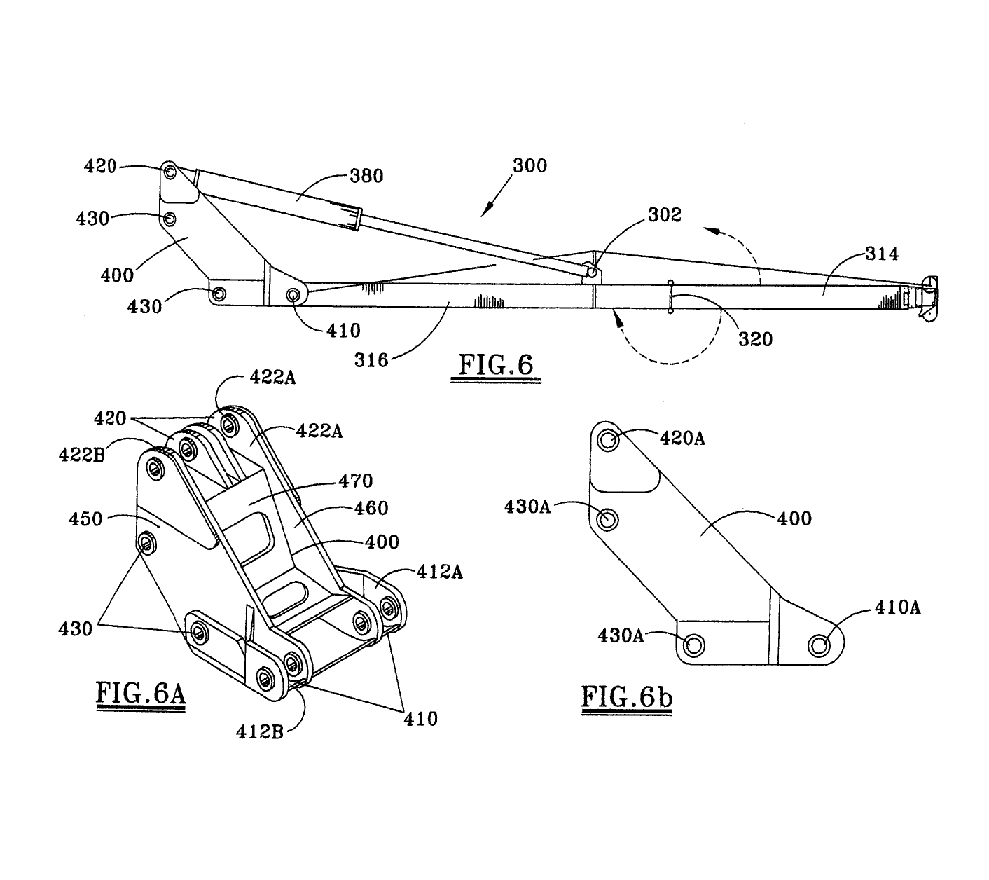

FIG. 6 is a side view of the adapter 400 and the lifting assembly 300 associated with the preferred embodiment of the pipelayer apparatus 10 of the present invention as illustrated in FIG. 1. The adaptor 400 is illustrated with a boom pivot 410, a cylinder pivot 420 and the connections 430 to the upper 200. The lifting assembly 300 is illustrated with the boom 310 and the cylinder 380. The boom 310 has the lower boom section 312, the upper boom section 314 and the boom pivot 320. It can be appreciated that the Boom 310 can be folded in either a clockwise direction or a counterclockwise direction as illustrated. The connections 302 and 420 removeably secure the cylinder 380 to the boom 310 and the adaptor 400, respectively.

FIG. 6A is a perspective view of the weldment or adapter 400 of the preferred embodiment of the pipelayer apparatus 10 of the present invention illustrated in FIG. 1. The adaptor 400 has a first side 450, a second side 460 and a connecting member 470. The first side 450, second side 460 and connecting member 470 have associated therewith doubler plates for providing extra reinforcement for the adaptor 400. At one end of the adaptor 400 is the boom pivot 410. The boom pivot 410 comprises the channels 412A, 412B for accepting the lower portion of the boom 310. At the other end of the adaptor 400 is the cylinder pivot 420. The cylinder pivot 420 comprises the channels 422A, 422B for accepting the cylinders 380. It is important to practice the present invention that the adaptor 400 be adapted to be accepted by the standard excavator upper, regardless of the specific configuration.

FIG. 6B is a side view of the weldment or adapter 400 of the preferred embodiment of the pipelayer apparatus 10 of the present invention illustrated in FIG. 1. The adaptor 400 illustrates the first side 450, the cylinder pivot 420, the boom pivot 410 and the connections 430 for engaging the upper 200.

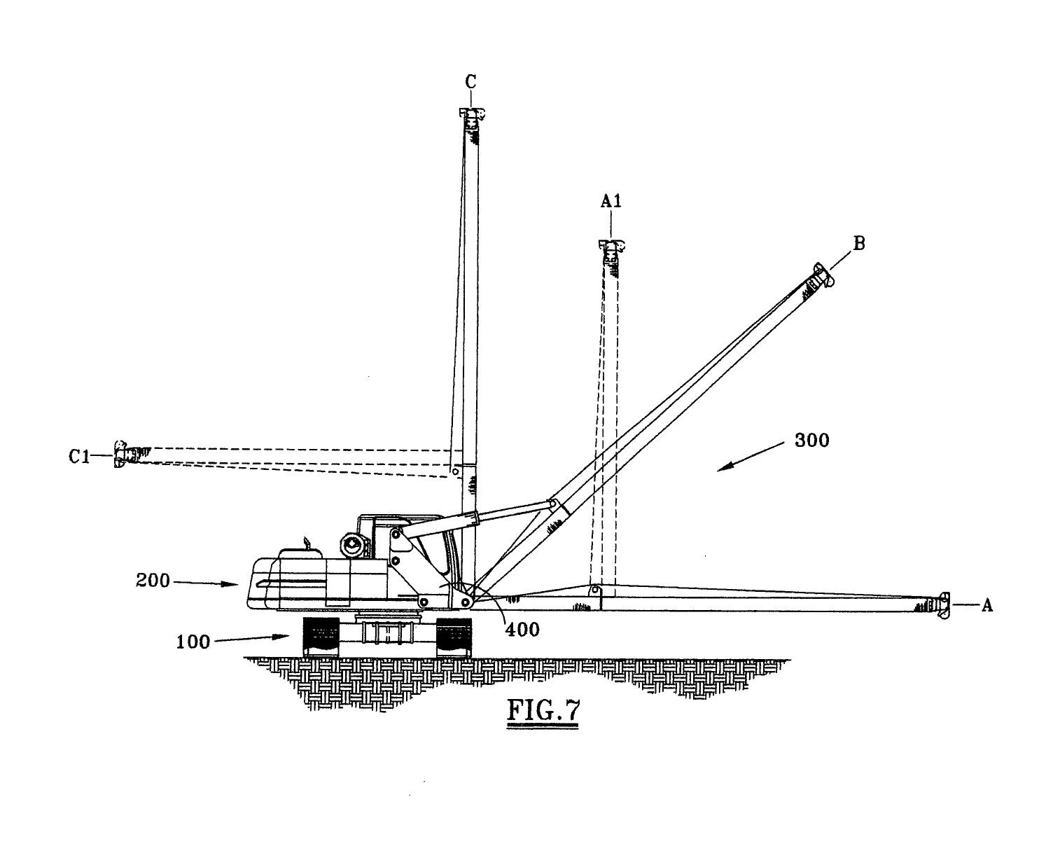

FIG. 7 is a side view of the preferred embodiment of the pipelayer crane apparatus 10 of the present invention illustrating the displacement of the boom 310 in a counterclockwise direction. The boom 310 is illustrated in position A, position B and position C. Further, the boom 310 when in position A can also be folded as illustrated in position A1. Still further, the boom 310 when in position C can also be folded as illustrated in position C1. It can be appreciated that the Boom 310 can be folded in either a clockwise direction or a counterclockwise direction as illustrated in FIG. 7.

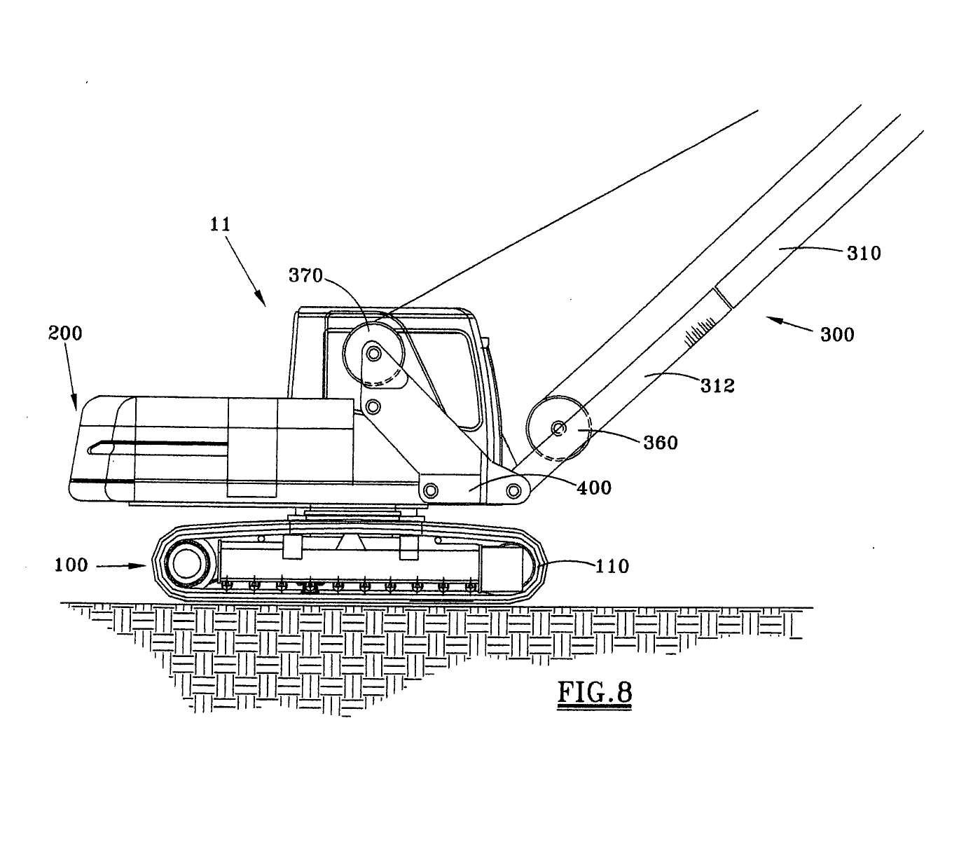

FIG. 8 is a side view of another preferred embodiment of the pipelayer apparatus 11 of the present invention illustrating a boom 310, and a two winch 360, 370 and adaptor 400 configuration. The load winch 360 is located in the lower portion of the boom or A-frame 310. A boom hoist winch 370 is provided in place of the cylinder in prior discussed embodiments. The boom hoist winch 370 is affixed to the portion of the adaptor 400 that previously held the cylinders.

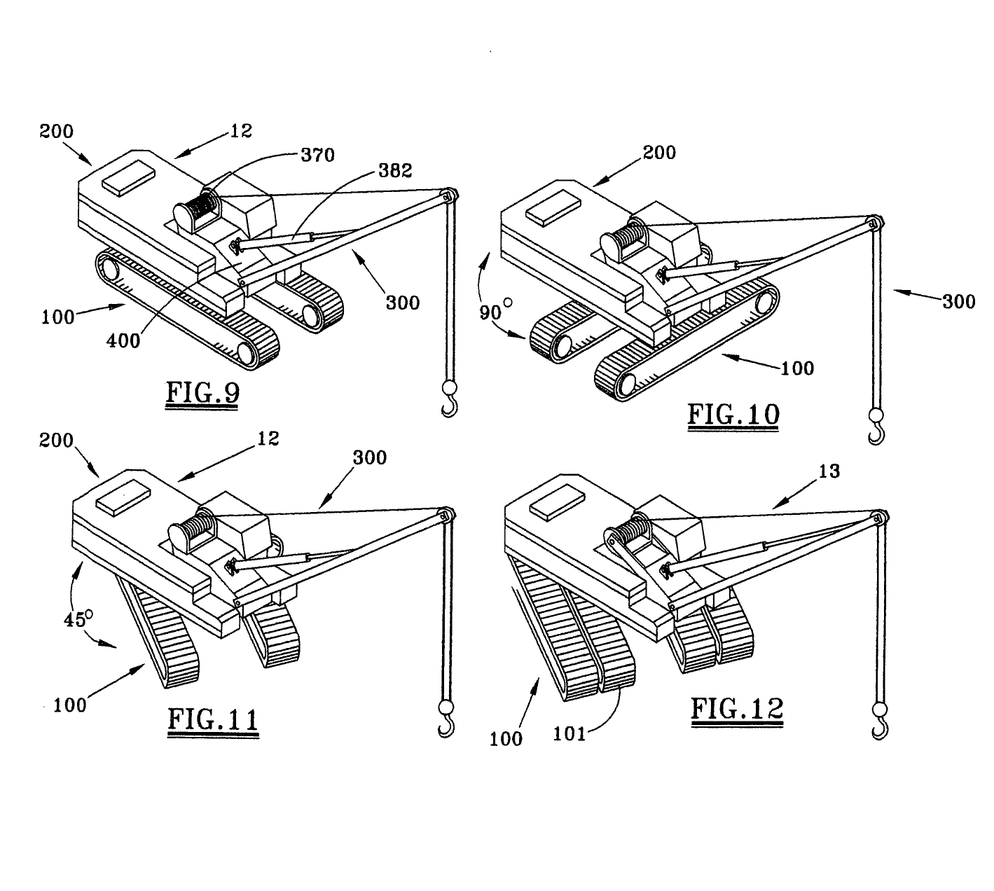

FIG. 9 is a perspective view of another preferred embodiment of the pipelayer apparatus 12 of the present invention illustrating a different lifting assembly 300, cylinder 382, winch 370 and adaptor 400 configuration.

FIG. 10 is a perspective view of the preferred embodiment of the pipelayer apparatus 12 of the present invention illustrated in FIG. 9 with the main frame 200 positioned 90 degrees from the undercarrage 100.

FIG. 11 is a perspective view of the preferred embodiment of the pipelayer apparatus 12 of the present invention illustrated in FIG. 9 with the main frame 200 positioned 45 degrees from the undercarrage 100.

FIG. 12 is a perspective view of the preferred embodiment of the pipelayer apparatus 13 of the present invention similar to the embodiment illustrated in FIG. 9 with the main frame 200 positioned 45 degrees from the undercarrage 100 and having duel tracks 101.

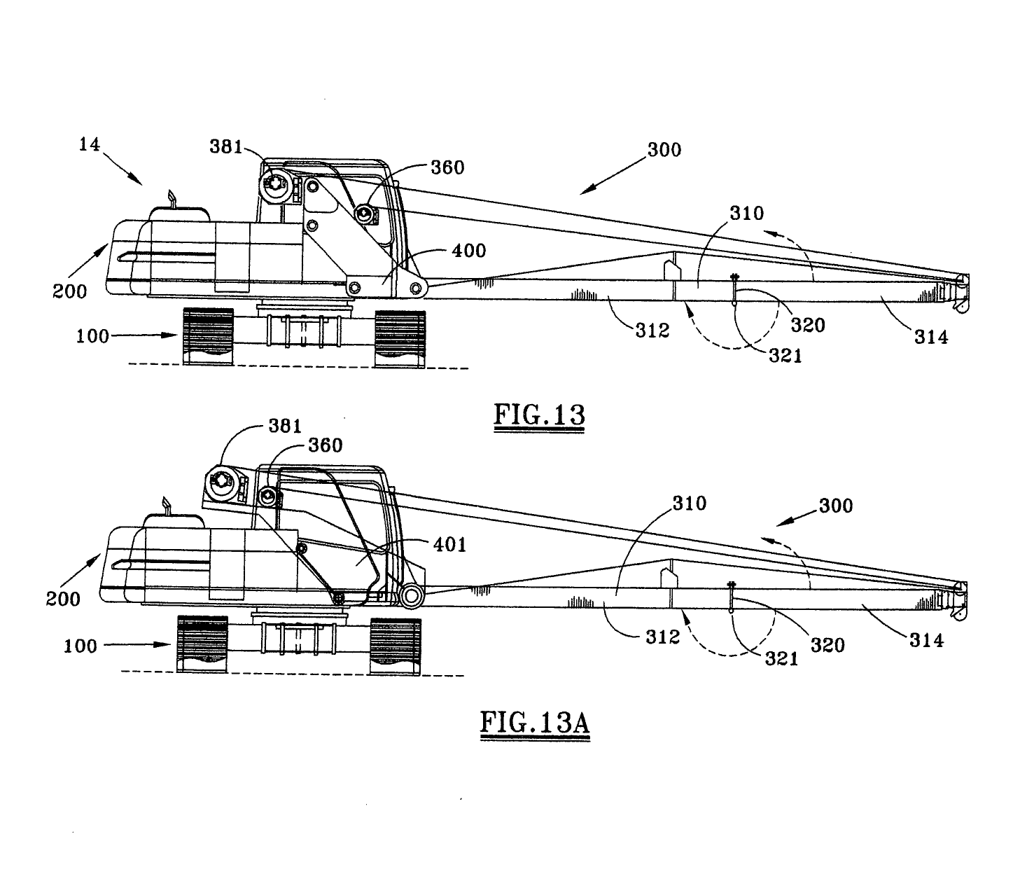

FIG. 13 is a side view of another preferred embodiment of the pipelayer apparatus 14 of the present invention illustrating a different lifting assembly 300, winch 360, 381 and adaptor 400 configuration. It can be appreciated that the boom 310 can be folded in either a clockwise direction or a counterclockwise direction about the pivot 320 as illustrated. The location of the winches 360, 381 are moved to the adaptor, and winch 381 replaces the cylinders.

FIG. 13A is a side view of yet another preferred embodiment of the pipelayer apparatus of the present invention illustrating a different lifting assembly 300, winch 360, 381 and adaptor 400 configuration. It can be appreciated that the boom 310 can be folded in either a clockwise direction or a counterclockwise direction about the pivot 320 as illustrated. The location of the winches 360, 381 are moved to the adaptor, and winch 381 replaces the cylinders.

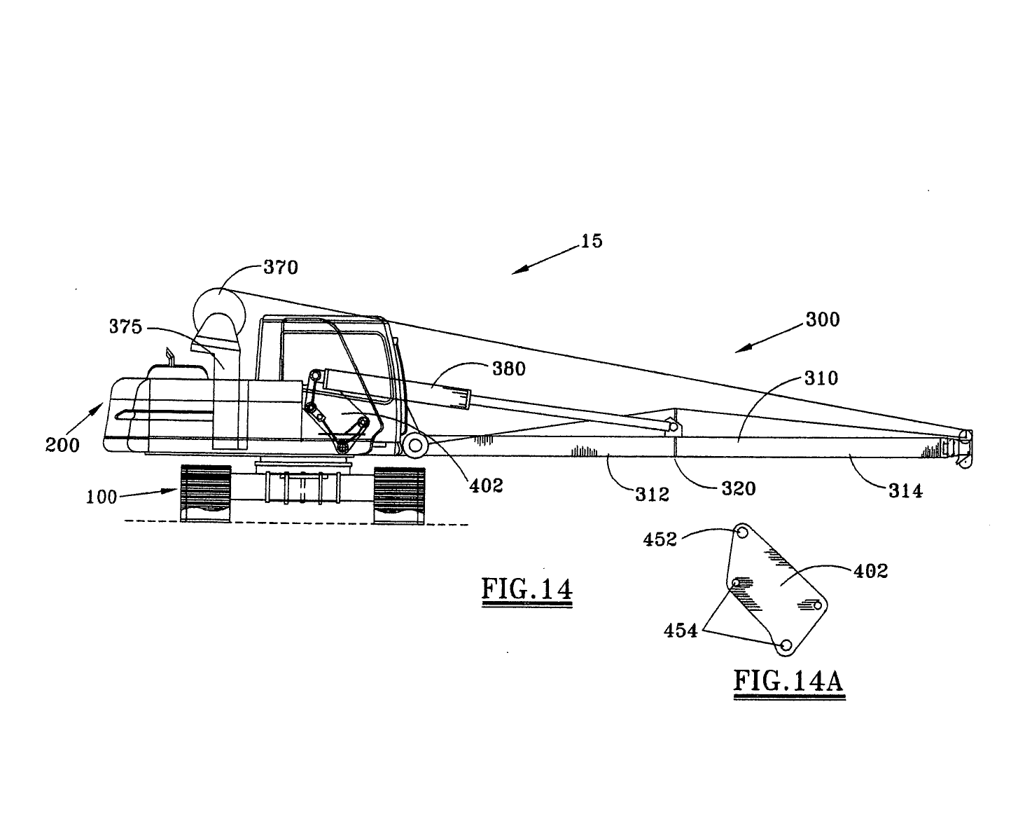

FIG. 14 is a side view of another preferred embodiment of the pipelayer apparatus 15 of the present invention illustrating a different boom 310, winch 370 and adaptor 400 configuration. FIG. 14A is a side view of the adaptor 400 used in the preferred embodiment of the pipelayer apparatus 15 of the present invention illustrated in FIG. 14.

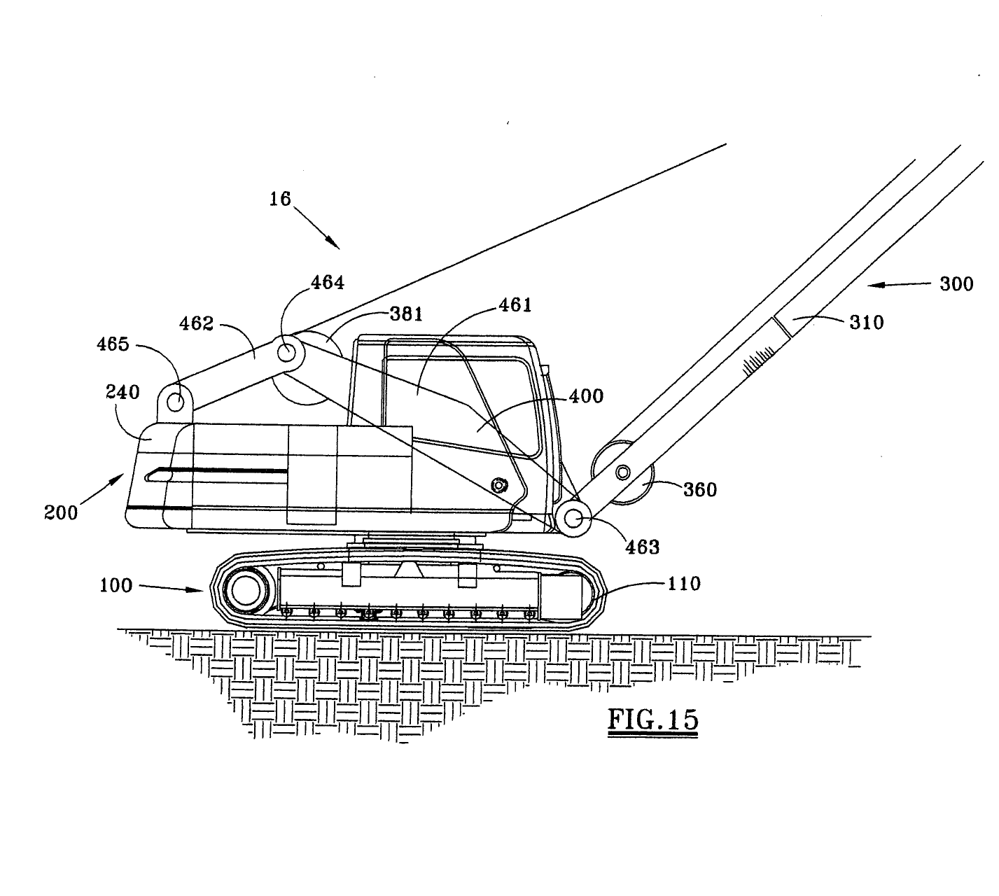

FIG. 15 is a side view of still another preferred embodiment of the pipelayer apparatus 16 of the present invention illustrating a boom 310, winch 360, 381 and adaptor 400 configuration. The adaptor 400 connects to the upper 200 at the connector 463 with the boom 310 and at the connector 465 at the counterweight 240. A central connector 464 secures the boom winch 381.

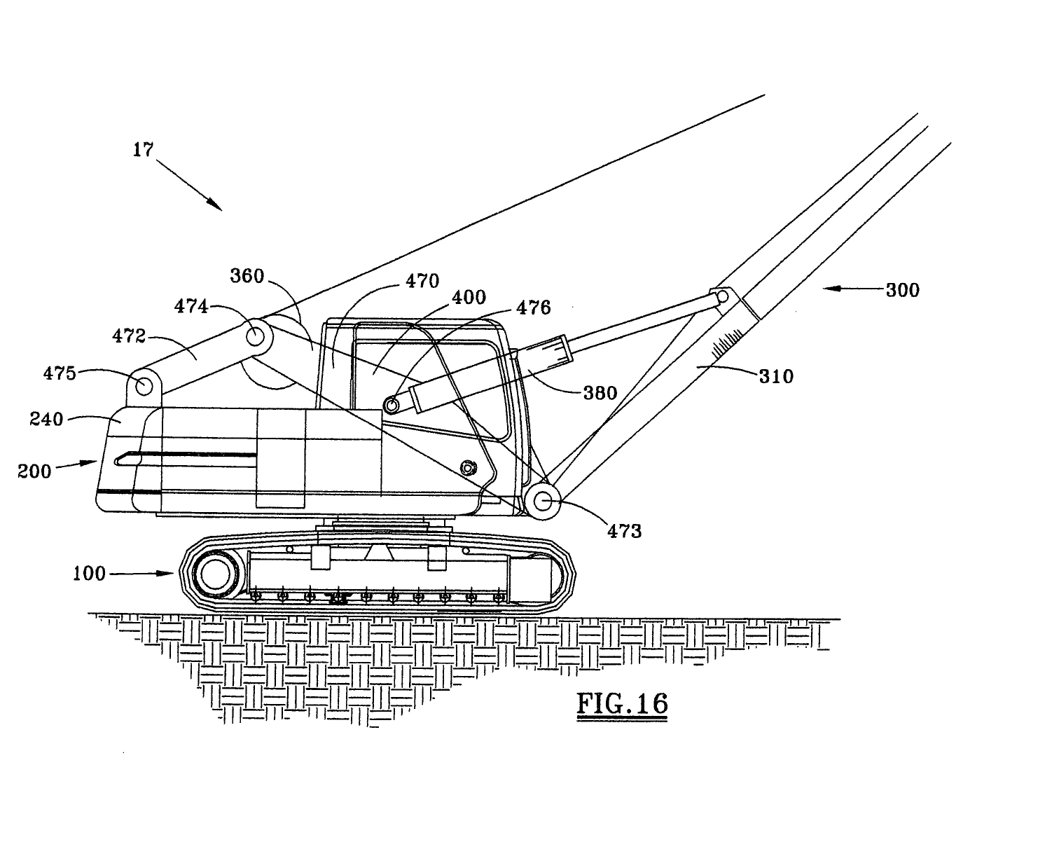

FIG. 16 is a side view of still another preferred embodiment of the pipelayer apparatus 17 of the present invention illustrating a different boom 310, cylinder 380, winch 360 and adaptor 400 configuration. The adaptor 400 connects to the upper 200 at the connector 473 with the boom 310 and at the connector 475 at the counterweight 240. A central connector 474 secures the boom winch 360.

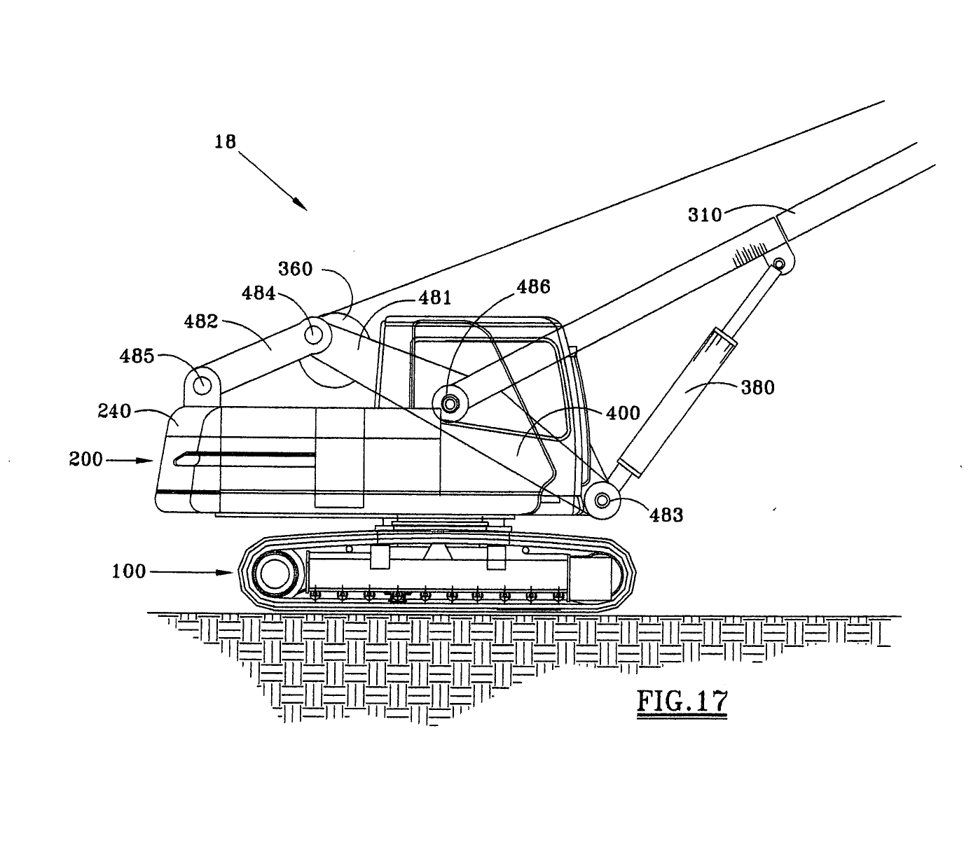

FIG. 17 is a side view of another preferred embodiment of the pipelayer apparatus 18 of the present invention illustrating a different boom 310, cylinder 380, winch 360 and weldment or adaptor 400 configuration. The adaptor 400 connects to the upper 200 at the connector 483 with the boom 310 and at the connector 485 at the counterweight 240. A central connector 484 secures the load winch 360.

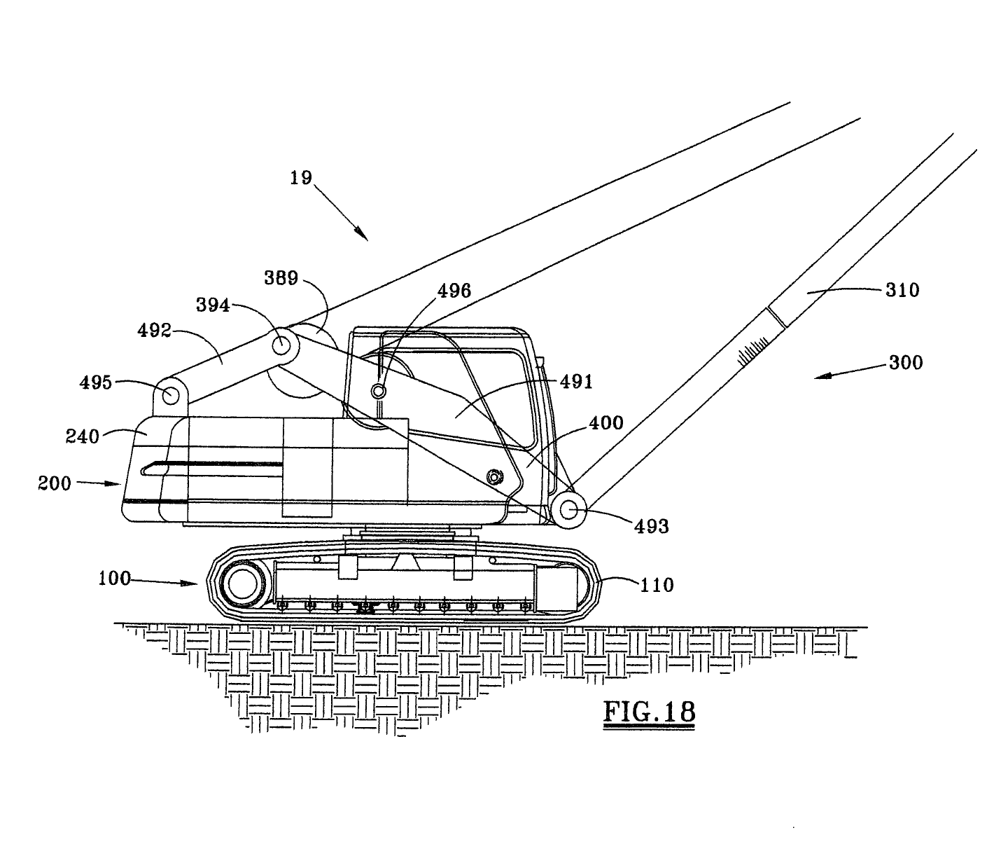

FIG. 18 is a side view of still another preferred embodiment of the pipelayer apparatus 19 of the present invention illustrating a boom 310, winch 369, 389 and weldment or adaptor 400 configuration. The adaptor 400 connects to the upper 200 at the connector 493 with the boom 310 and at the connector 495 at the counterweight 240. A central connector 494 secures the winch 389, and connector 496 secures the winch 369.

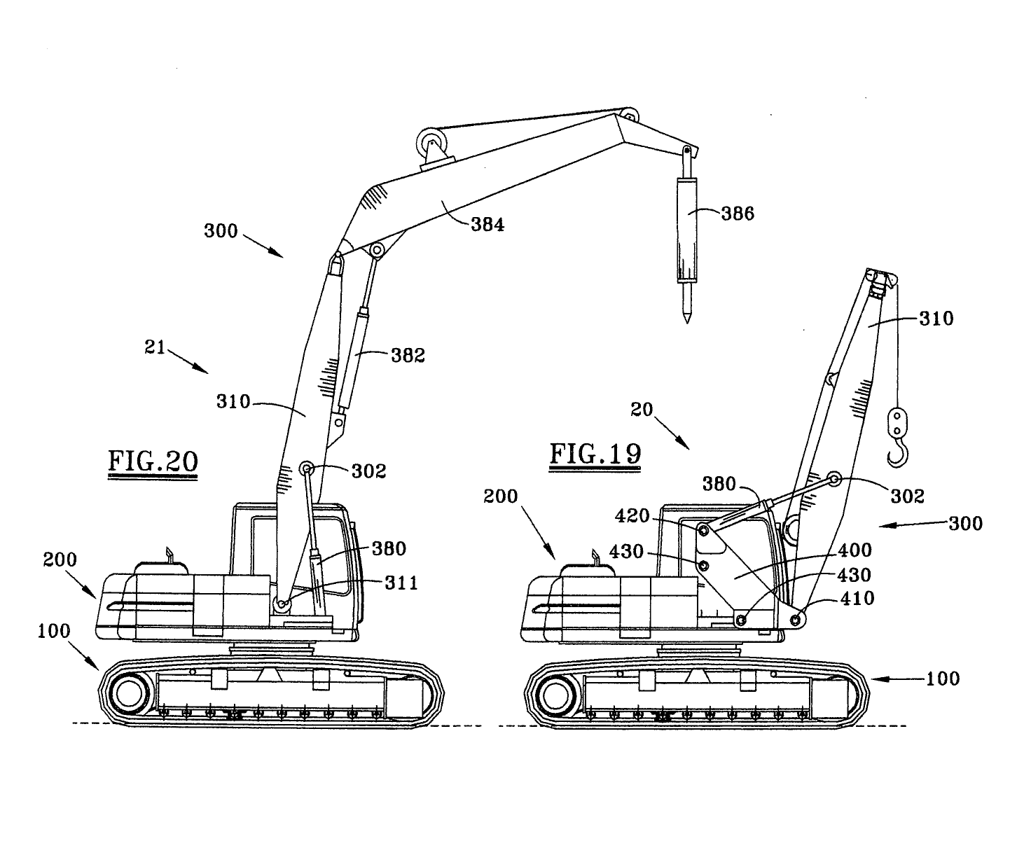

FIG. 19 is a side view of still another preferred embodiment of the pipelayer apparatus 20 of the present invention illustrating a boom 310 attached with or without a weldment or adaptor 400.

FIG. 20 is a side view of still another preferred embodiment of a modified pipelayer apparatus 21 of the present invention having the boom 310 attached to the main frame 200 and a jib boom 384 attached to the boom 310 and a tool 386 attached to the jib boom 384.

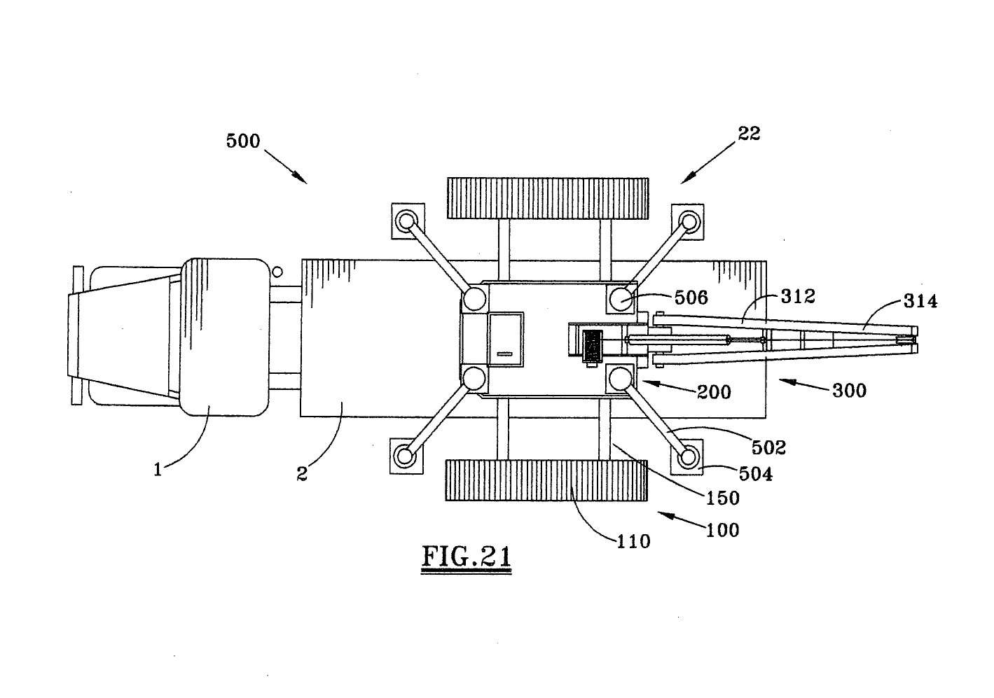

FIG. 21 is a plan view illustrating a preferred method of self-loading for the pipelayer apparatus of the present invention showing the pipelayer apparatus 22 straddling a trailer 2, and an associated truck 1.

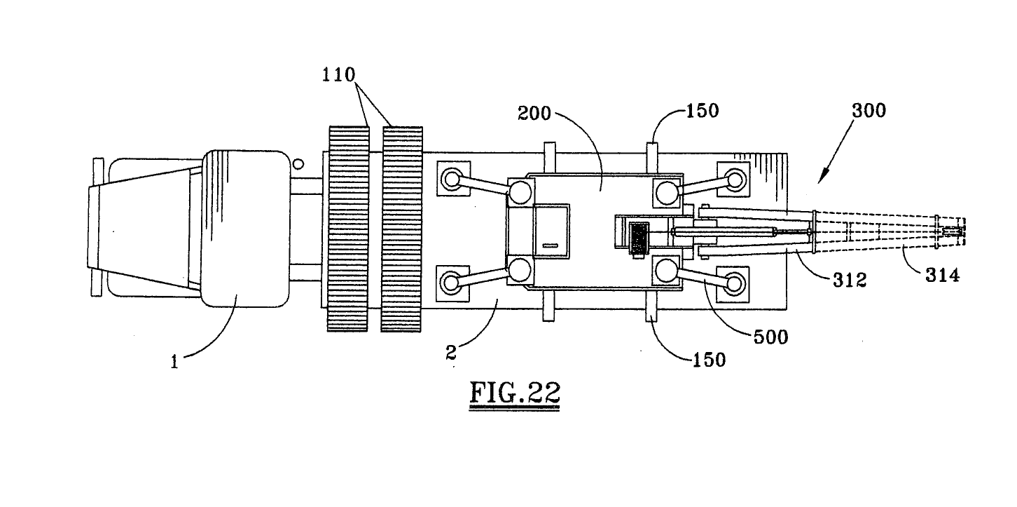

FIG. 22 is a plan view illustrating the preferred method of self-loading for the pipelayer apparatus of the present invention illustrated in FIG. 21 showing the pipelayer apparatus 22 self-loaded on the trailer 2. Generally, the arms 502 are extended so the pads 504 cam support the apparatus 22. The trailer is backed under the apparatus 22. The upper 200 is lowered on the truck. The tracks are removed. The crane lifts the tracks on the trailer 2. The crane boom is folded. And the apparatus is ready for transport.

Additional advantages and modification will readily occur to those skilled in the art. The invention in its broader aspects is therefore not limited to the specific details, representative apparatus, and the illustrative examples shown and described herein. Accordingly, departures may be made from the details without departing from the spirit or scope of the disclosed general inventive concept.

What is claimed is:

1. A pipelayer crane apparatus comprising:
a lower, the lower comprising a lower frame, a pedestal, a lower bearing portion, a telescoping axle, a track roller, and a track shoe;
an upper, the upper comprising a frame, a body, a cab, a pedestal, a upper bearing portion, and a counterweight;
a lifting assembly, the lifting assembly comprising an adjacent portion, a remote portion, a joint, and a cylinder;
a weldment, the weldment comprising a body, an extension, a winch, and securing members.

2. The pipelayer crane of claim 1 further comprising a boom that articulates at the joint.

3. The pipelayer crane of claim 1 further comprising the securing means of the weldment attached to either the adjacent portion or the cylinder.

4. The pipelayer crane of claim 1 further comprising the winch attached to the upper.

5. The pipelayer crane of claim 1 further comprising the lifting assembly comprised of a plurality of cylinders.

6. The pipelayer crane of claim 1 further comprising a lifting assembly with a plurality of additional portions.

7. The pipelayer crane of claim 1 further comprising the weldment attached to the upper in a plurality of locations.

8. The pipelayer crane of claim 1 further comprising a cable system to articulate the lifting assembly.

9. A pipelayer crane apparatus comprising:
a lower, the lower comprising a lower frame, a pedestal, a lower bearing portion, a telescoping axle, a track roller, and a track shoe;
an upper, the upper comprising a frame, a body, a cab, a pedestal, a upper bearing portion, and a counterweight;
a lifting assembly, the lifting assembly comprising an adjacent portion, a remote portion, a joint, and a cylinder; and
a weldment, the weldment comprising a body, an extension, a winch, and securing members.

10. A method for a pipelayer crane apparatus to rotate about the track shoes comprising:
a lower, the lower having a pedestal attached to a lower bearing surface;
an upper, the upper having a pedestal attached to a upper bearing portion;
bearing formed by the interaction of the upper bearing surface and the lower bearing surface;
a pipe lifting assembly, the pipe lifting assembly attached to a weldment, the weldment attached to the upper; and
the upper rotating about the bearing formed by the upper bearing surface and the lower bearing surface.
